(19) United States
(12) Patent Application Publication
(10) Pub. No.: US 2025/0165370 A1
(43) Pub. Date: May 22, 2025

(54) FAILURE INFORMATION DETECTING APPARATUS, FAILURE INFORMATION DETECTING METHOD, AND FAILURE INFORMATION DETECTING PROGRAM

(71) Applicant: NIPPON TELEGRAPH AND TELEPHONE CORPORATION, Tokyo (JP)

(72) Inventors: Nobukazu FUKUDA, Musashino-shi (JP); Chao WU, Musashino-shi (JP); Shingo HORIUCHI, Musashino-shi (JP); Kenichi TAYAMA, Musashino-shi (JP)

(73) Assignee: NIPPON TELEGRAPH AND TELEPHONE CORPORATION, Tokyo (JP)

(21) Appl. No.: 18/840,941

(22) PCT Filed: Feb. 28, 2022
(86) PCT No.: PCT/JP2022/008352

§ 371 Date: Aug. 23, 2024

(51) Int. Cl. G06F 11/30; G06F 16/334

(52) U.S. Cl. CPC G06F 11/3086; G06F 16/3347

(57) ABSTRACT

A failure information detecting apparatus according to an embodiment includes a data acquisition unit that acquires a plurality of metrics including time series data and metadata and a failure query indicating a failure that a user desires to specify from a monitored system, a metric encoder that calculates a first vector representation of the plurality of metrics, a failure query encoder that calculates a second vector representation of the failure query, and a failure information detecting unit that calculates a first similarity between the first vector representation and the second vector representation and detects a failure in the metrics based on the first similarity.

### TECHNICAL FIELD

The present invention relates to a failure information detecting apparatus, a failure information detecting method, and a failure information detecting program.

### BACKGROUND ART

Conventionally, in a method of performing failure detection using a large number of metrics acquired from a monitored system, it takes time to detect a failure when the number of metrics is large. Therefore, the number of metrics needs to be reduced to facilitate analysis by a user or a model.

For example, Non Patent Literature 1 proposes a technique of extracting metrics related to a root cause using a time-series causal search. In addition, for example, Non Patent Literature 2 proposes a technique of reducing metrics by a unit root test and time series clustering.

### CITATION LIST

### Non Patent Literature

Non Patent Literature 1: Thalheim, Jörg et al. “Sieve: actionable insights from monitored metrics in distributed systems.” Proceedings of the 18th ACM/IFIP/USENIX Middleware Conference (2017)
Non Patent Literature 2: Tsubouchi, Y. at al., “TSifter: Dimension Reduction of Time Series Data for Quick Diagnosis of Performance Issues in Microservices”, IOTS, 2020

### SUMMARY OF INVENTION

### Technical Problem

In order to improve the failure detection speed, it is necessary to extract metrics that are considered to be necessary from a large number of metrics (hereinafter referred to as pruning), but there is a problem that the metrics regarding the failure that the user desires to identify (hereinafter referred to as intention of the user) are dropped by pruning.

For example, the techniques proposed in Non Patent Literature 1 and Non Patent Literature 2 cannot identify failure information. Therefore, these techniques have a problem that the user's intention cannot be reflected.

The present invention has been made in view of the above circumstances, and an object of the present invention is to provide a technique capable of accurately detecting a failure reflecting a user's intention.

### Solution to Problem

In order to solve the above problem, one aspect of the present invention is a failure information detecting apparatus including a data acquisition unit that acquires a plurality of metrics including time series data and metadata and a failure query indicating a failure that a user desires to specify from a monitored system, a metric encoder that calculates a first vector representation of the plurality of metrics, a failure query encoder that calculates a second vector representation of the failure query, and a failure information detecting unit that calculates a first similarity between the first vector representation and the second vector representation and detects a failure in the metrics based on the first similarity.

### Advantageous Effects of Invention

According to one aspect of the present invention, the validity determining apparatus can determine validity of an output result from an input and output correspondence using a trained model.

### BRIEF DESCRIPTION OF DRAWINGS

FIG. 1 is a schematic diagram illustrating a usage example of a failure information detecting apparatus according to an embodiment.

FIG. 2 is a block diagram illustrating an example of a hardware configuration of the failure information detecting apparatus according to the embodiment.

FIG. 3 is a block diagram illustrating a software configuration of the failure information detecting apparatus of the embodiment in association with the hardware configuration illustrated in FIG. 2.

FIG. 4 is a flowchart illustrating an example of an operation for the failure information detecting apparatus to detect a failure.

FIG. 5 is a diagram illustrating an example of metrics acquired by a related metric extraction unit.

FIG. 6 is a diagram conceptually illustrating operations illustrated in Steps ST104 to ST108.

FIG. 7 is a diagram illustrating operations illustrated in steps ST106 to ST108 in more detail.

FIG. 8 is a view illustrating an example of an F1 value of each pruning method.

### DESCRIPTION OF EMBODIMENTS

Hereinafter, embodiments according to this invention will be described with reference to the drawings. Note that, hereinafter, the same or similar reference signs will be given to components that are the same as or similar to those already described, and redundant description will be basically omitted. For example, in a case where there are a plurality of same or similar components, a common reference sign may be used to describe the components without distinction of the components, or a branch number may be used in addition to the common reference sign to describe the components with the components distinguished.

### Embodiment

### (Configuration)

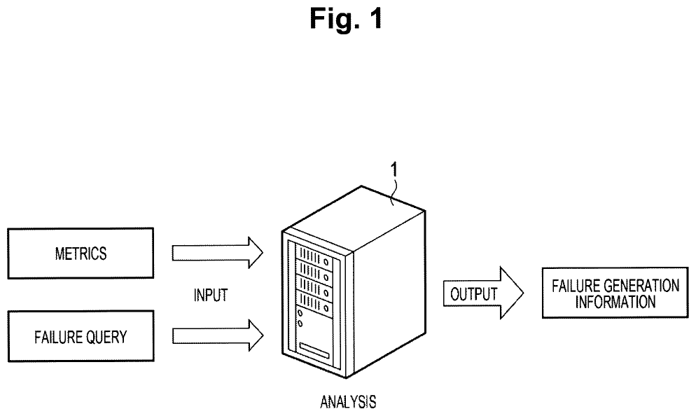

FIG. 1 is a schematic diagram illustrating a usage example of a failure information detecting apparatus 1 according to an embodiment.

As illustrated in FIG. 1, the failure information detecting apparatus 1 is a computer that analyzes input data and generates and outputs output data. The failure information detecting apparatus 1 receives, as input data, a plurality of metrics output from the monitored system and a failure query indicating a failure that the user desires to specify.

The failure information detecting apparatus 1 analyzes the received metrics and failure query to create failure occurrence information. Then, the failure information detecting apparatus 1 outputs failure occurrence information as output data. The failure information detecting apparatus 1 can transmit and receive various types of information to and from an external apparatus via a network connected in a wired or wireless manner, for example. In addition, the failure information detecting apparatus 1 may read a failure query or a metric from a built-in or externally connected storage device. The failure information detecting apparatus 1 may transmit and receive various types of information to and from an input and output device integrally provided with or connected as an extension to the failure information detecting apparatus 1.

In the present application, a “monitored system (also simply referred to as a “target system”)” may include a system related to a wide variety of service maintenance work. The monitored system includes, for example, one or more apparatus and one or more applications constituting a wide range of networks from a small scale network to a large scale network. It goes without saying that the monitored system may be the failure information detecting apparatus 1 and an application executed by the failure information detecting apparatus 1. The failure information detecting apparatus 1 can periodically collect metrics from apparatus or applications constituting the monitored system.

The “user” in the present application includes any user who can directly or indirectly input the user's intention (failure query) to the failure information detecting apparatus 1. The “user” may also be a single user or may include multiple users. The user includes, for example, an operator, a developer, an administrator, a designer, or the like involved in a monitored system, a monitoring system, or service maintenance work.

“Metrics” in the present application include time-series data and metadata indicating service performance, resource usage, and the like. Each piece of time-series data includes a set of time stamps and other data values at each time. Each piece of metadata includes text information such as a name, a variable name, and a container name assigned to a metric. In addition, although the failure information detecting apparatus 1 receives a plurality of metrics, in the following description, they are simply referred to as metrics for the sake of simplicity.

In addition, the “failure query” in the present application indicates a failure that the user desires to specify, and includes text data. For example, the failure query may be a text “I want to specify a failure of a link stage”. The failure query may be one that can be created by a user or any program in free expression and free language.

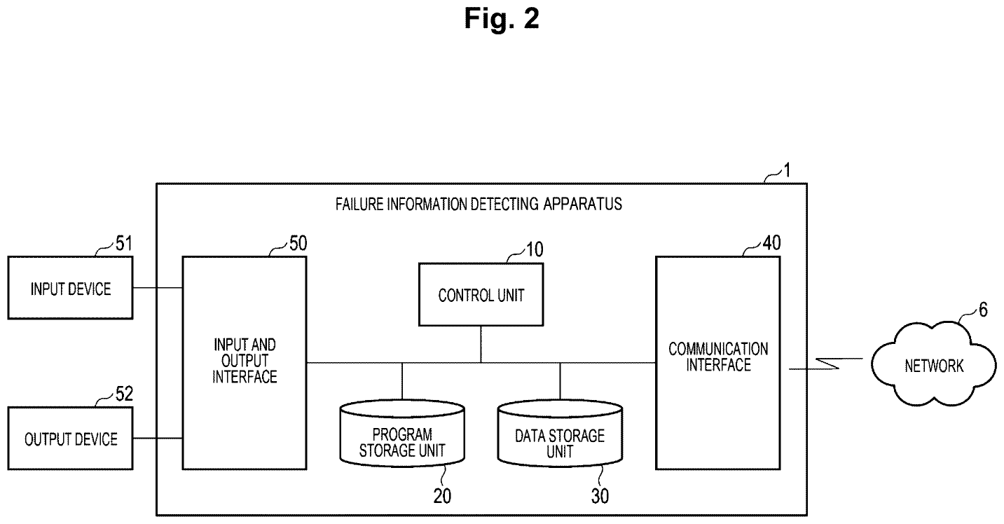

FIG. 2 is a block diagram illustrating an example of a hardware configuration of the failure information detecting apparatus 1 according to the embodiment.

As illustrated in FIG. 2, the failure information detecting apparatus 1 includes a control unit 10, a program storage unit 20, a data storage unit 30, a communication interface 40, and an input and output interface 50. The control unit 10, the program storage unit 20, the data storage unit 30, the communication interface 40, and the input and output interface 50 are communicably connected with each other via a bus. Furthermore, the communication interface 40 is communicably connected to an external apparatus via a network 6. Furthermore, the input and output interface 50 is communicably connected to an input device 51 and an output device 52.

The control unit 10 controls the failure information detecting apparatus 1. The control unit 10 includes a hardware processor such as a central processing unit (CPU). For example, the control unit 10 may be an integrated circuit capable of executing various programs.

The program storage unit 20 can be used using, as a storage medium, a combination of a nonvolatile memory to and from which writing and reading can be performed as needed, such as an erasable programmable read only memory (EPROM), a hard disk drive (HDD), or a solid state drive (SSD), and a nonvolatile memory such as a read only memory (ROM), for example. The program storage unit 20 stores programs necessary for executing various types of processing. That is, the control unit 10 can implement various controls and operations by reading and executing the program stored in the program storage unit 20.

The data storage unit 30 is a storage using, as a storage medium, a combination of a nonvolatile memory to and from which writing and reading can be performed as needed, such as an HDD or a memory card, and a volatile memory such as a random access memory (RAM), for example. The data storage unit 30 is used to store data acquired and generated in a process in which the control unit 10 executes a program to perform various types of processing.

The communication interface 40 includes one or more wired or wireless communication modules. For example, the communication interface 40 includes a communication module that establishes wired or wireless connection with an external apparatus via the network 6. The communication interface 40 may include a wireless communication module wirelessly connected to an external apparatus such as a Wi-Fi access point and a base station. Further, the communication interface 40 may include a wireless communication module that performs wireless connection with an external apparatus using a short-distance wireless technique. That is, the communication interface 40 may be a general communication interface as long as it can communicate with an external apparatus and transmit and receive various types of information under the control of the control unit 10.

The input and output interface 50 is connected to the input device 51, the output device 52, and the like. The input and output interface 50 is an interface that enables transmission and reception of information between the input device 51 and the output device 52. The input and output interface 50 may be integrated with the communication interface 40. For example, the failure information detecting apparatus 1 and at least one of the input device 51 and the output device 52 are wirelessly connected using a short-range wireless technique or the like, and may transmit and receive information using the short-range wireless technique.

The input device 51 includes, for example, a keyboard, a pointing device, and the like for the user to input various types of information including the operator's intention to the failure information detecting apparatus 1. Moreover, the input device 51 may include a reader for reading data to be stored in the program storage unit 20 or the data storage unit 30 from a memory medium such as a USB memory, and a disk device for reading such data from a disk medium.

The output device 52 includes a display that displays output data to be presented to the user by the failure information detecting apparatus 1, a printer that prints the output data, and the like.

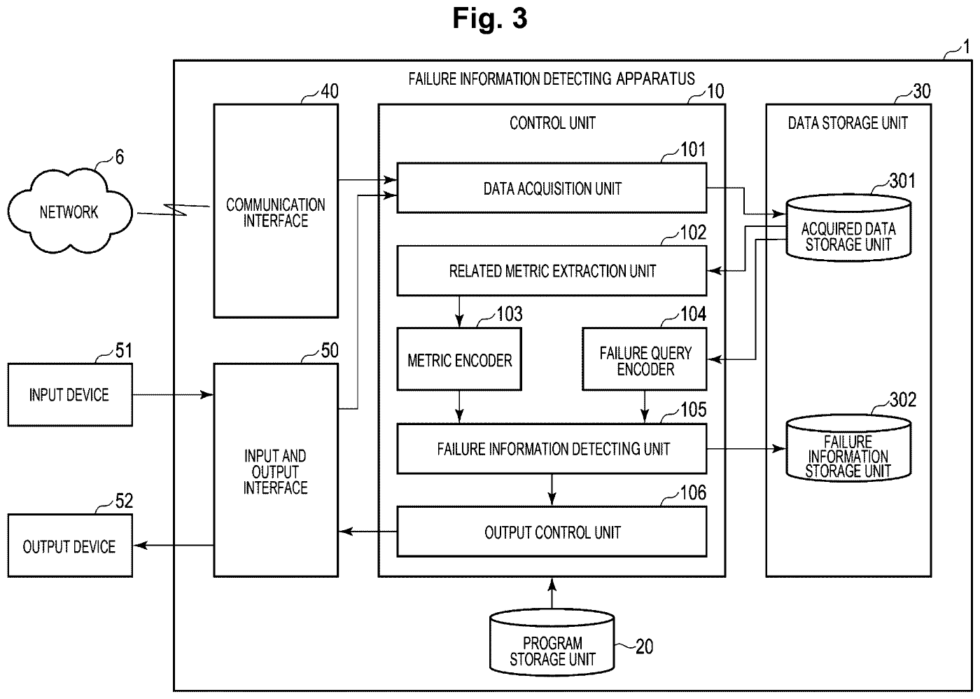

FIG. 3 is a block diagram illustrating a software configuration of the failure information detecting apparatus 1 of the embodiment in association with the hardware configuration illustrated in FIG. 2.

The control unit 10 includes a data acquisition unit 101, a related metric extraction unit 102, a metric encoder 103, a failure query encoder 104, a failure information detecting unit 105, and an output control unit 106. In addition, the data storage unit 30 includes an acquired data storage unit 301 and a failure information storage unit 302.

The data acquisition unit 101 acquires various type of data from the input device 51 through the communication interface 40 and the input and output interface 50. For example, the data acquisition unit 101 acquires metrics from the communication interface 40. Further, the data acquisition unit 101 acquires the intention of the operator from the input device 51. Here, the intention of the operator may be a failure query indicating failure information desired to be specified by the user who is the operator. The data acquisition unit 101 stores the acquired metrics and the failure query in the acquired data storage unit 301.

The related metric extraction unit 102 calculates an abnormality score based on the plurality of metrics acquired by the data acquisition unit 101. Note that details of the calculation method of the abnormality score will be described later. Furthermore, the related metric extraction unit 102 extracts (pruning) a first metric from a plurality of metrics based on the calculated abnormality score. Then, the related metric extraction unit 102 further extracts (pruning) second metrics similar to the failure query from the first metrics based on the failure query and the metadata of the first metrics. Here, details of the two pruning methods will be described later. The related metric extraction unit 102 outputs the extracted second metrics to the metric encoder 103.

The metric encoder 103 calculates a vector representation (first vector representation) of the extracted second metrics. Here, details of a calculation method of the vector representation will be described later. Then, the metric encoder 103 outputs the vector representation of the second metrics and the second metrics to the failure information detecting unit 105.

The failure query encoder 104 calculates a vector representation of the failure query. For example, the failure query encoder 104 acquires the failure query stored in the acquired data storage unit 301. The failure query encoder 104 then calculates a vector representation of the failure query using a general text encoder. Then, the failure query encoder 104 outputs the calculated vector representation of the failure query and the failure query to the failure information detecting unit 105.

The failure information detecting unit 105 calculates the similarity between the vector representation of the metrics and the vector representation of the failure query. For example, the failure information detecting unit 105 can use a cosine similarity, a Lp distance, distance measures of various embedded expressions, and the like to calculate similarity of vector representations. Further, the failure information detecting unit 105 determines whether the calculated similarity exceeds a predetermined threshold value. For example, in a case where it is determined that the similarity exceeds the predetermined threshold value, the failure information detecting unit 105 determines that a failure has occurred. Then, the failure information detecting unit 105 outputs failure information indicating that a failure has occurred for the metric for which the similarity has been calculated to the output control unit 106. Conversely, in a case where the similarity is less than the predetermined threshold value, the failure information detecting unit 105 may determine that no failure has occurred in the metrics for which the similarity has been calculated.

The output control unit 106 outputs the failure information received from the failure information detecting unit 105 to the output device 52 through the input and output interface 50.

### (Operation)

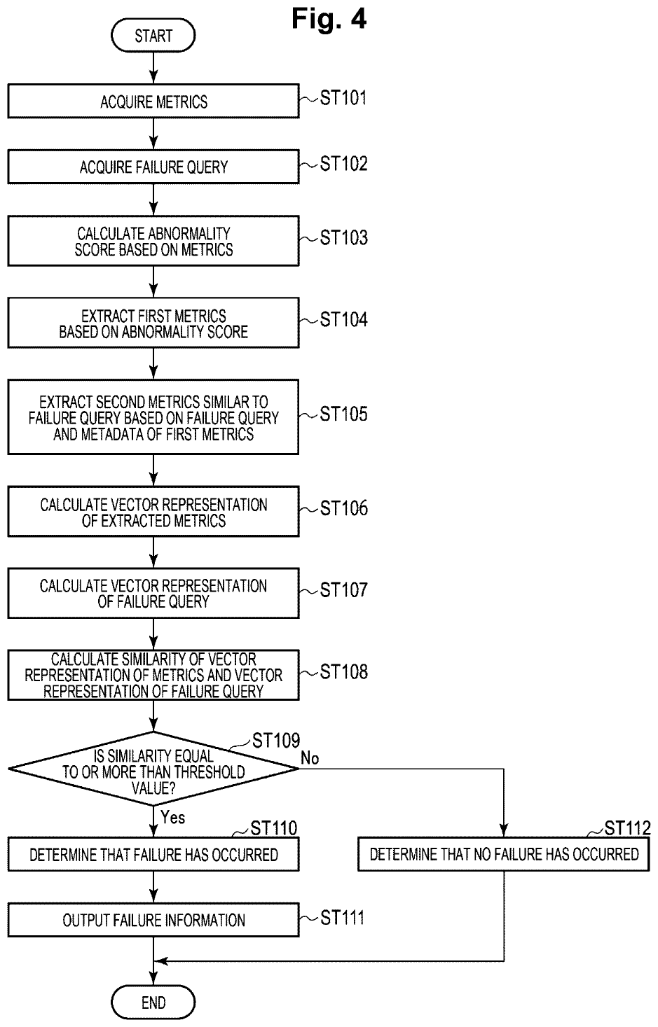

FIG. 4 is a flowchart illustrating an example of an operation for the failure information detecting apparatus 1 to detect a failure.

The control unit 10 of the failure information detecting apparatus 1 reads and executes a program stored in the program storage unit 20, thereby implementing the operation of this flowchart.

The operation may be started by a user's instruction. In this case, the data acquisition unit 101 may acquire the metrics and the failure query in advance and store the metrics and the failure query in the acquired data storage unit 301. Alternatively, the operation may be started when the failure information detecting apparatus 1 receives the failure query. For example, the data acquisition unit 101 may acquire metrics in advance or at all times and store the metrics in the acquired data storage unit 301.

The related metric extraction unit 102 acquires metrics from the acquired data storage unit 301 (Step ST101). The metrics may be acquired from the monitored system in advance by the data acquisition unit 101 and stored in the acquired data storage unit 301.

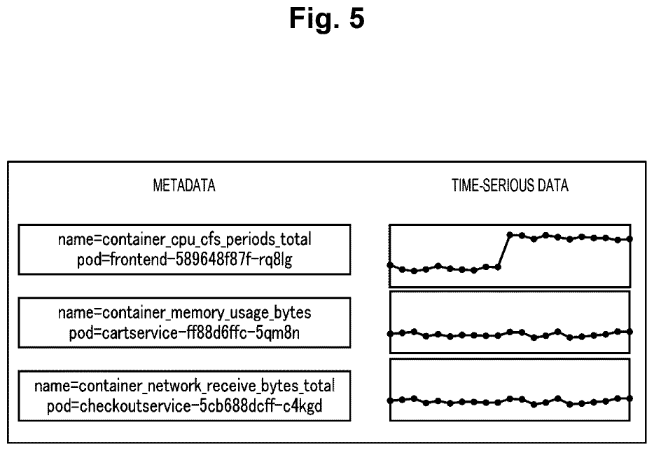

FIG. 5 is a diagram illustrating an example of metrics acquired by the related metric extraction unit 102.

As illustrated in FIG. 5, the metrics include metadata and time series data. In the example of FIG. 5, the metadata indicates text data of name and pod, but it is a matter of course that other text data may be included.

The related metric extraction unit 102 acquires the failure query from the acquired data storage unit 301 (Step ST102). Note that the failure query may be acquired in advance by the data acquisition unit 101 and stored in the acquired data storage unit 301. Alternatively, the control unit 10 may cause the output device 52 to display information prompting the user to input the failure query, and use the failure query input by the user to the input device 51.

The related metric extraction unit 102 calculates an abnormality score based on the metrics data (Step ST103). The related metric extraction unit 102 calculates an abnormality score based on the time-series data included in the metrics. For example, the related metric extraction unit 102 may calculate an abnormality score using one-dimensional time-series abnormality detection for time-series data. For example, as the one-dimensional time-series abnormality detection, a method such as Spectral Residual (SR method) or a Fourier transform based abnormality detecting method can be used. For example, the related metric extraction unit 102 calculates an abnormality score for the time-series data of the metrics using the SR method. Note that the related metric extraction unit 102 may calculate an abnormality score for each metric.

The related metric extraction unit 102 extracts first metrics based on the calculated abnormality score (Step ST104). For example, the related metric extraction unit 102 may extract metrics having an abnormality score higher than a predetermined score (threshold value). In other words, the related metric extraction unit 102 extracts (pruning) a first metric having time-series data with abnormal fluctuations during the time window from a plurality of metrics.

The related metric extraction unit 102 extracts a second metric similar to the failure query based on the failure query and the metadata of the first metric (Step ST105). First, the related metric extraction unit 102 calculates the similarity of the character strings between the failure query and the metadata of the first metrics. For example, methods such as an editing distance, a longest common substring, and a Q-gram similarity can be used to calculate the similarity of the character string. The related metric extraction unit 102 calculates the similarity of the character string using, for example, the editing distance. Then, the related metric extraction unit 102 extracts, for example, a second metric having a calculated similarity equal to or higher than a predetermined similarity (threshold value) from the first metrics using Pruning. That is, the related metric extraction unit 102 extracts (pruning) the second metrics related to the failure query from the first metrics by character string search. Then, the related metric extraction unit 102 outputs the second metrics to the metric encoder 103.

As described above, the related metric extraction unit 102 performs the first pruning on the metrics stored in the acquired data storage unit 301 based on the abnormality score. Then, the related metric extraction unit 102 performs the second pruning on the first metrics having been subjected to the first pruning based on the character string search. As described above, the related metric extraction unit 102 can extract only the metrics in which the failure that the user desires to specify has occurred by performing pruning twice on the metrics.

The metric encoder 103 calculates a vector representation of the extracted metrics (Step ST106). For example, the vector representation can be computed using a Transformer or other model. For example, the metric encoder 103 simultaneously encodes the time stamp and the data value of the time series data using the Transformer. For example, the metric encoder 103 converts a timestamp representing an absolute time included in the metadata into a timestamp representing a relative time within the time window. As a result, asynchronous time-series data can be uniformly handled. The metric encoder 103 calculates vector representations from time stamps representing relative times and other data values for each metric and aggregates the vector representations. As a result, the metric encoder 103 can uniformly handle the asynchronous time-series data. As a result, the metric encoder 103 can capture a relationship between asynchronous metrics. Further, the metric encoder 103 simultaneously learns the time-series data and the metadata using, for example, a Transformer. As a result, the metric encoder 103 calculates a vector representation of a metric that is an encoding result. The metric encoder 103 outputs the vector representation of the calculated metrics and the metrics to the failure information detecting unit 105.

The failure query encoder 104 calculates a vector representation of the failure query (Step ST107). The failure query encoder 104 acquires the failure query stored in the acquired data storage unit 301. Then, the failure query encoder 104 calculates a vector representation of a failure query of text described in a natural sentence using a general text encoder. For example, the failure query encoder 104 may calculate the vector representation of the failure query using a text encoder included in the metric encoder 103. Then, the failure query encoder 104 outputs the calculated vector representation of the failure query to the failure information detecting unit 105.

The failure information detecting unit 105 calculates the similarity between the vector representation of the metrics and the vector representation of the failure query (Step ST108). The failure information detecting unit 105 may calculate similarity (s∈[−1, 1]) using cosine similarity, for example.

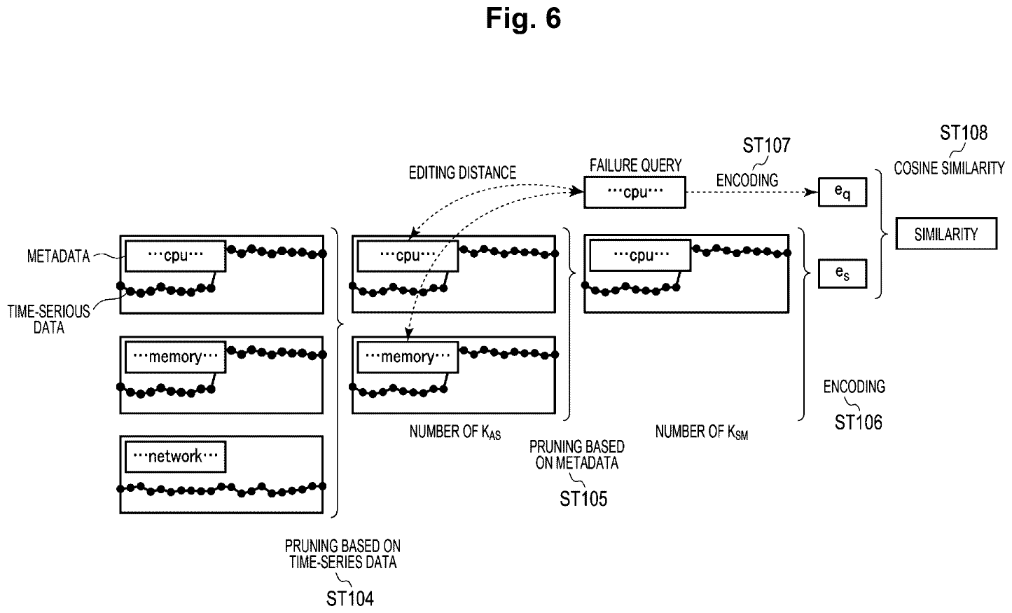

FIG. 6 is a diagram conceptually illustrating operations illustrated in Steps ST104 to ST108.

As described in Step ST104, the related metric extraction unit 102 performs pruning based on the time-series data from the metrics stored in the acquired data storage unit 301, and extracts K_{AS} metrics (first metrics) from a plurality of metrics. Next, as described in Step ST105, the related metric extraction unit 102 performs pruning based on the metadata, and extracts K_{SM} metrics (second metrics) from the K_{AS} metrics. Here, K_{AS}>K_{SM} is satisfied. Further, as described in Steps ST106 and ST107, the metric encoder 103 and the failure query encoder 104 encode the second metrics and the failure query (calculation of vector representation) (In FIG. 6, denoted as eₛ and e_{q}, respectively). Then, as described in Step ST108, the failure information detecting unit 105 calculates the similarity between the vector representation eₛ of the second metrics and the vector representation e_{q} of the failure query using, for example, cosine similarity.

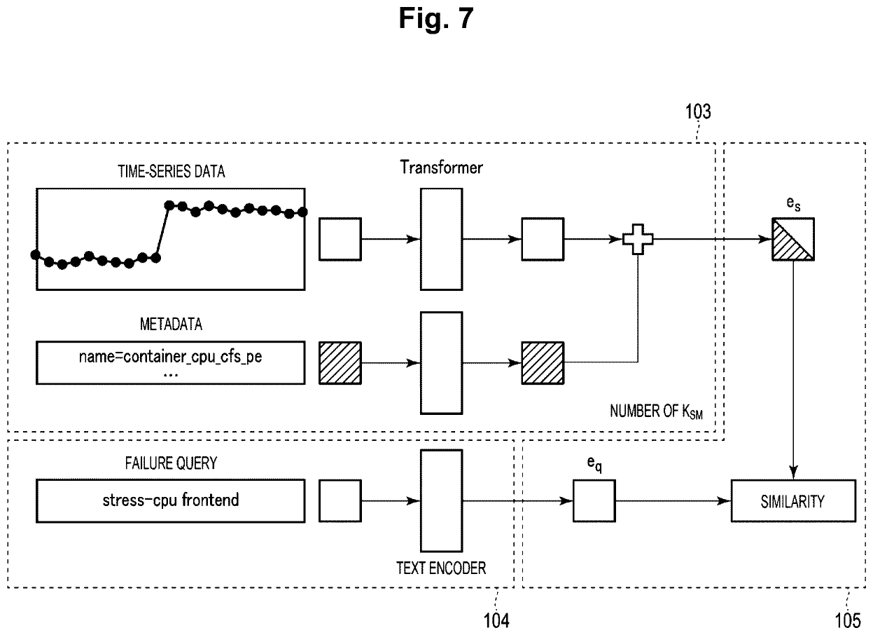

FIG. 7 is a diagram illustrating operations illustrated in steps ST106 to ST108 in more detail.

As illustrated in FIG. 7, the metric encoder 103 calculates a vector representation eₛ of metrics using, for example, a Transformer, and the failure query encoder 104 calculates a vector representation e_{q} of a failure query using a text encoder. Then, the failure information detecting unit 105 calculates the similarity between the vector representation eₛ of the second metrics and the vector representation e_{q} of the failure query using, for example, cosine similarity.

The failure information detecting unit 105 determines whether the similarity is a predetermined threshold value or more (Step ST109). For example, the predetermined threshold value may be 0. In a case where the similarity is equal to or greater than the predetermined threshold value, the processing proceeds to Step ST110. On the other hand, in a case where the similarity is less than the predetermined threshold value, the processing proceeds to Step ST112.

Note that the failure information detecting unit 105 naturally performs the processing of Steps ST106 to ST109 on each of the second metrics.

The failure information detecting unit 105 determines that a failure has occurred (Step ST110). That is, the failure information detecting unit 105 determines that the metric used for the determination is the failure that the user desires to specify. Therefore, the failure information detecting unit 105 generates failure information indicating that a failure has occurred for the metric for which the similarity has been calculated. In addition, the failure information may include information about the metrics and the failure query used to determine the similarity. Then, the failure information detecting unit 105 outputs the generated failure information to the output control unit 106.

The output control unit 106 outputs failure information to the output device 52 through the input and output interface 50 (Step ST111). The output device 52 that has received the failure information displays the failure information on a display or the like.

The failure information detecting unit 105 determines that no failure has occurred (Step ST112). The failure information detecting unit 105 determines that the metrics used for the determination are not failures that the user desires to specify. In this case, the failure information detecting unit 105 may output information indicating that no failure has occurred to the output control unit 106. The output control unit 106 may output the information to the output device 52.

### Experiments

In the following description, an example of an experiment based on the operation described above will be described.

In experiments, the monitored system uses Online Boutique built on Kubernetes. The related metric extraction unit 102 uses the SR method for calculating the abnormality score. Furthermore, the related metric extraction unit 102 uses the editing distance to calculate the similarity between the character strings of the failure query and the metadata of the metrics. The failure information detecting unit 105 uses cosine similarity to calculate similarity between vector representations.

The failure information detecting apparatus 1 first performs supervised learning using data collected from the monitored system. Then, the failure information detecting apparatus 1 detects a failure using test data including metrics and a failure query. As an evaluation method, an F1 value at the time of failure detection is calculated. That is, the failure information detecting apparatus 1 determines whether a failure designated by the failure query occurs using the test data. Then, the user calculates the F1 value for a case where a failure has occurred using a predetermined program.

In addition, as the pruning method to be compared, F1 values of a method in which abnormality detection is performed using only the abnormality score (the metrics extracted in Step ST104 described with reference to FIG. 4), a method in which abnormality detection is performed using only character string search (the metrics extracted in Step ST105 described with reference to FIG. 4), and a method in which abnormality detection is performed using the abnormality score+character string search (the metrics extracted in Step ST104+Step ST105) are calculated.

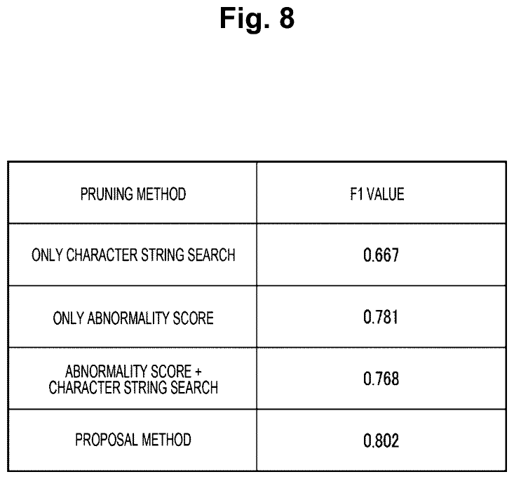

FIG. 8 is a view illustrating an example of the F1 value of each pruning method.

As illustrated in FIG. 8, the method (In FIG. 8, described as the proposed technique) described with reference to FIG. 4 is larger than the F1 value to be compared, indicating that the accuracy is improved.

In addition, the F1 values of the abnormality score+character string search and the abnormality score alone indicate similar values. However, in the abnormality detection in the abnormality score+character string search, it is considered that only metrics in which a failure desired to be specified by the user has occurred are extracted.

### Function and Effect

According to the embodiment, the failure information detecting apparatus 1 can detect the failure designated by the failure query using the metrics and the semantic information of the failure query. In addition, as shown in the experimental result, the failure information detecting apparatus 1 can accurately detect a failure reflecting the intention of the user.

### Other Embodiments

In the above-described embodiment, the example in which the pruning is performed twice has been described. However, the failure information detecting apparatus 1 may perform the pruning of only one of the pruning. Further, the failure information detecting apparatus 1 may not perform the pruning twice. For example, in a case where the number of metrics is small, the failure information detecting apparatus 1 may not perform pruning.

In addition, the methods described in the above-described embodiments can be stored in a storage medium such as a magnetic disk (floppy (registered trademark) disk, hard disk, or the like), an optical disk (CD-ROM, DVD, MO, or the like), or a semiconductor memory (ROM, RAM, flash memory, or the like) as programs (software means) that can be executed by a computing machine (computer), or can also be distributed by being transmitted through a communication medium. Note that the programs stored on the medium side also include a setting program for configuring, in the computing machine, a software means (not only an execution program but also tables and data structures are included) to be executed by the computing machine. The computing machine that implements the present apparatus reads the program stored in the storage medium, constructs the software means by the setting program as the case may be, and executes the above-described processing by the operation being controlled by the software means. Note that the storage medium described in the present specification is not limited to a storage medium for distribution, and includes a storage medium such as a magnetic disk or a semiconductor memory provided in a apparatus connected inside a computer or via a network.

In short, the present invention is not limited to the above-described embodiment, and various modifications can be made in the implementation stage without departing from the gist thereof. In addition, the embodiments may be implemented in appropriate combination if possible, and in this case, combined effects can be obtained. Further, the above-described embodiments include inventions at various stages, and various inventions can be extracted by appropriate combinations of a plurality of the disclosed requirements.

### REFERENCE SIGNS LIST

1 Failure information detecting apparatus
10 Control unit
101 Data acquisition unit
102 Related metric extraction unit
103 Metric encoder
104 Failure query encoder
105 Failure information detecting unit
106 Output control unit
20 Program storage unit
30 Data storage unit
301 Acquired data storage unit
302 Failure information storage unit
40 Communication interface
50 Input and output interface
51 Input device
52 Output device
6 Network

1. A failure information detecting apparatus comprising:
circuitry configured to
acquire a plurality of metrics including time series data and metadata and a failure query indicating a failure that a user desires to specify from a monitored system;
calculate a first vector representation of the plurality of metrics;
calculate a second vector representation of the failure query; and
calculate a first similarity between the first vector representation and the second vector representation and detects a failure in the metrics based on the first similarity.

2. The failure information detecting apparatus according to claim 1, wherein the circuitry is further configured to:
calculate an abnormality score based on the metrics and extracts a first metric from the plurality of metrics based on the abnormality score.

3. The failure information detecting apparatus according to claim 2, wherein the circuitry is further configured to:
extract a second metric similar to the failure query from the first metric based on the failure query and the first metric.

4. The failure information detecting apparatus according to claim 3, wherein the circuitry is further configured to:
calculate a second similarity between metadata of the first metric and a character string of the failure query, and extract a second metric having the second similarity exceeding a predetermined threshold value from the first metric.

5. The failure information detecting apparatus according to claim 3, wherein the first vector representation is a vector representation of the second metric.

6. The failure information detecting apparatus according to claim 1, wherein the circuitry is further configured to:
detect whether a failure occurs in the metrics based on whether the first similarity exceeds a predetermined threshold value.

7. A failure information detecting method executed by a failure information detecting apparatus, the method comprising:
acquiring a plurality of metrics including time series data and metadata and a failure query indicating a failure that a user desires to specify from a monitored system;
calculating a first vector representation of the plurality of metrics;
calculating a second vector representation of the failure query;
calculating a first similarity between the first vector representation and the second vector representation; and
detecting a failure in the metrics based on the first similarity.

8. A non-transitory computer readable storage medium storing a computer program which is executed by a failure information detecting apparatus to provide the steps of:
acquiring a plurality of metrics including time series data and metadata and a failure query indicating a failure that a user desires to specify from a monitored system;
calculating a first vector representation of the plurality of metrics;
calculating a second vector representation of the failure query;
calculating a first similarity between the first vector representation and the second vector representation; and
detecting a failure in the metrics based on the first similarity.
